(19) United States
(12) Patent Application Publication
(10) Pub. No.: US 2010/0094715 A1
(43) Pub. Date: Apr. 15, 2010

(54) SYSTEM FOR CREATING MENU BOARD AND FOOD ORDERING SYSTEM USING ELECTRONIC MENU BOARD MODULE

(75) Inventors: Byoung Chul KIM, Imsil-gun (KR); Min Ju KANG, Jeonju-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: NYTEL CO., LTD., Jeonju-si (KR)

(21) Appl. No.: 12/553,639

(22) Filed: Sep. 3, 2009

(30) Foreign Application Priority Data
Oct. 9, 2008 (KR) 10-2008-0099122

(51) Int. Cl. G06Q 50/00; G06Q 30/00

(52) U.S. Cl. 705/15; 705/14.49

(57) ABSTRACT

The present invention relates to a system for creating a menu board and a food ordering system using an electronic menu board module. The system for creating a menu board includes a main server including a template information DB for storing menu board template information related to configuration and arrangement of various menu boards, and a menu board creation tool for creating a menu board using the menu board template information. A restaurant client PC is connected to the main server over a network, and is configured to include a menu board information DB for storing configuration sources of each menu board, created using the menu board creation tool of the main server, and a print output unit for outputting the menu board through a printer. The menu board is printed through the printer and is usable as a typical menu board.

### BACKGROUND OF THE INVENTION

1. Field of the Invention

The present invention relates generally to a system for creating a menu board, which can conveniently create a menu board, and a food ordering system using an electronic menu board module. More particularly, the present invention relates to a food ordering system using an electronic menu board module, which enables the menu boards of an electronic menu board module to be easily created and updated in restaurants, that is, affiliated companies, and which not only prevents the names of food items from being incorrect because unified food information represented in various languages is provided to restaurants, but also allows foreign tourists to conveniently select desired food items because they have been easily informed of information about the food of Korea.

2. Description of the Related Art

Generally, when a customer visits a place to eat such as a Korean or western restaurant, a member of the serving staff guides the customer to a table, hands over a menu board on which menu information is printed to the customer, and then accepts an order by manually writing the contents of an order on an order sheet.

In the case of a menu board on which menu information is printed, when new food items are added or when the entire menu design is intended to be changed, a menu board must be newly created requiring at the present time that a lot of money be spent.

Further, since menu boards are respectively created in restaurants, the names of food items may be incorrectly displayed at the time of creating the menu boards. Furthermore, since respective food items go by different names in different restaurants without there being unified naming, customers may be confused by the names of food items. In particular, in the case of English or Japanese, a large number of ungrammatical menu boards have been used, so that it is difficult to transmit correct food information to foreign tourists, stopping them from being able to easily find and order desired food items.

### SUMMARY OF THE INVENTION

Accordingly, the present invention has been made keeping in mind the above problems occurring in the prior art, and an object of the present invention is to provide a system for creating a menu board, which can allow menu boards to be conveniently created at a low cost in restaurants, and to be easily changed and created when menu items are changed, and which, in particular, can prevent the names of food items from being incorrect.

Another object of the present invention is to provide a food ordering system using an electronic menu board module, which not only can easily change and update an existing menu board without requiring the creation of a new menu board when food items are added in restaurants, but also can prevent the names of food items from being incorrect by providing unified food information represented in various languages to restaurants, and can allow foreign tourists to easily select desired food items by informing the foreign tourists of correct food information.

In order to accomplish the above objects, the present invention provides a system for creating a menu board, comprising a main server including a template information database (DB) for storing menu board template information related to configuration and arrangement of various menu boards, and a menu board creation tool for creating a menu board using the menu board template information stored in the template information DB; and at least one restaurant client Personal Computer (PC) connected to the main server over a network, and configured to include a menu board information DB for storing configuration sources of each menu board, created using the menu board creation tool of the main server, over a web and a print output unit for outputting the menu board, created using the menu board creation tool, through a printer, wherein the menu board created using the menu board creation tool is printed through the printer and is usable as a typical menu board.

Preferably, the main server comprises a food information DB for storing food information which includes names of various food items and is represented in various languages.

In addition, the present invention provides a food ordering system using an electronic menu board module, comprising a main server including a main board creation tool for creating a menu board using menu board template information related to configuration and arrangement of various menu boards; at least one restaurant client Personal Computer (PC) connected to the main server over a network, and configured to include a menu board information DB for storing configuration sources of each menu board, created using the menu board creation tool of the main server, over a web, a wireless transmission unit for transmitting the menu board configuration sources in a wireless manner, a wireless reception unit for receiving order information in a wireless manner, and an order information DB for storing the order information received by the wireless reception unit; and a plurality of electronic menu board modules, each including a wireless reception unit for receiving configuration sources of a menu board, transmitted from the restaurant client PC, in a wireless manner, a menu board information DB for storing the menu board configuration sources received by the wireless reception unit, a menu board driving unit for configuring and driving the menu board by analyzing the menu board configuration sources received by the wireless reception unit, a display unit for outputting the menu board driven by the menu board driving unit, an input unit for selecting and inputting food items based on the menu board output to the display unit, an order information DB for storing the order information input to the input unit, and a wireless transmission unit for transmitting the order information to the restaurant client PC.

Preferably, the main server comprises a food information DB for storing food information which includes names, materials, cooking methods and taste of various food items and is represented in various languages, and the menu board creation tool comprises a language conversion unit for conveniently converting the food information into information in a specific language.

Preferably, each table of the restaurant comprises a Radio Frequency Identification (RFID) tag for storing table information, each of the electronic menu board modules comprises a Radio Frequency (RF) reception unit for receiving an RF signal from the RFID tag, and a table determination unit for determining table information in response to the RF signal received by the RF reception unit, and the wireless transmission unit of the electronic menu board module transmits the table information determined by the table determination unit to the restaurant client PC.

Preferably, the menu board template information stored in the main server comprises a menu board template equipped with an advertisement display unit, and the main server further comprises an advertisement information DB for storing advertisement information, targeted advertisement type, and other types of advertisement-related information of an affiliated advertiser company, and an advertisement information output unit for transmitting the advertisement information stored in the advertisement information DB to the restaurant client PC.

Preferably, the menu board driven by the electronic menu board module comprises an evaluation display unit for enabling evaluation of respective food items and results of the evaluation to be checked, and the results of the evaluation of the food items performed using the input unit and displayed by the evaluation display unit are stored in an evaluation information DB, and the results of the evaluation of the food items stored in the evaluation information DB are stored both in the restaurant client PC and in the main server.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing a system for creating a menu board according to the present invention;

FIG. 2 is a block diagram schematically showing a main server;

FIG. 3 is a block diagram schematically showing a restaurant client PC;

FIG. 4 is a block diagram schematically showing a food ordering system using an electronic menu board module according to the present invention;

FIG. 5 is a block diagram schematically showing the construction of a main server;

FIGS. 6A to 6C are diagrams schematically showing examples of a menu board template;

FIG. 7 is a diagram schematically showing an example of a menu board template equipped with an advertisement display unit;

FIG. 8 is a diagram schematically showing the configuration of a menu board equipped with a language selection unit;

FIG. 9 is a diagram schematically showing the construction of a restaurant client PC;

FIG. 10 is a flowchart schematically showing the flow of a food ordering system;

FIG. 11 is a flowchart schematically showing the reception of advertisement information by the restaurant client PC;

FIG. 12 is a diagram schematically showing the configuration of an electronic menu board module;

FIG. 13 is a diagram schematically showing an electronic menu board module and a table;

FIG. 14 is a flowchart schematically showing a process in which the electronic menu board module determines table information; and

FIG. 15 is a diagram schematically showing the provision of a kitchen terminal, a serving member terminal, and a bulletin terminal.

### DESCRIPTION OF THE PREFERRED EMBODIMENTS

Reference now should be made to the drawings, in which the same reference numerals are used throughout the different drawings to designate the same or similar components.

Hereinafter, embodiments of a system for creating a menu board and a food ordering system using an electronic menu board module according to the present invention will be described in detail with reference to the attached drawings. The scope of the present invention is not to be limited by the embodiments.

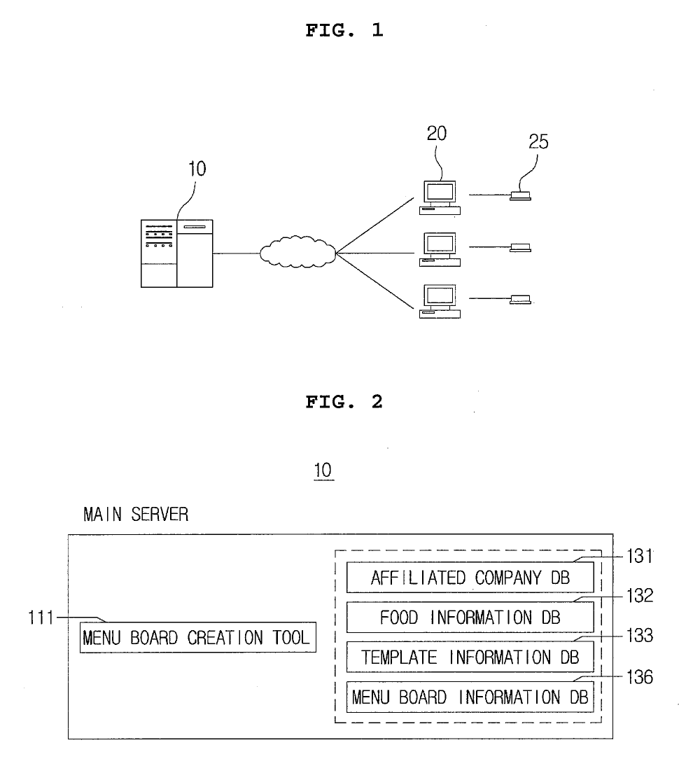

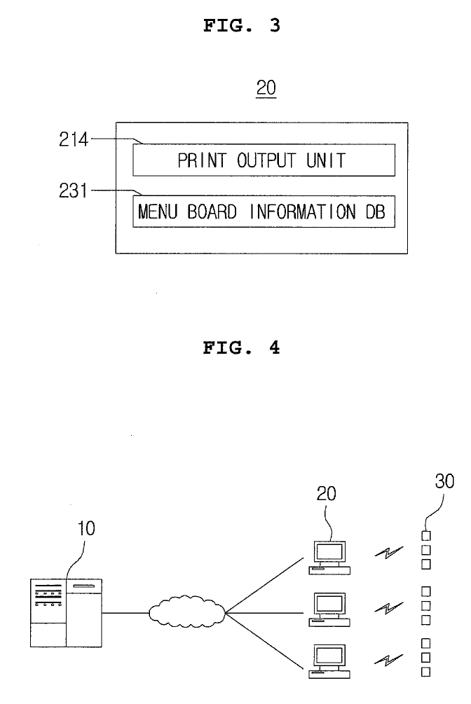

FIG. 1 is a diagram schematically showing a system for creating a menu board according to the present invention, FIG. 2 is a block diagram schematically showing a main server, and FIG. 3 is a block diagram schematically showing a restaurant client Personal Computer (PC).

As shown in FIGS. 1 to 3, the system for creating a menu board according to the present invention includes a main server 10 and a plurality of restaurant client PCs 20. The main server 10 includes a template information database (DB) 133 for storing menu board template information related to the configuration and arrangement of various menu boards, and a menu board creation tool 111 for creating a menu board using the menu board template information stored in the template information DB 133. Each of the restaurant client PCs 20 includes a menu board information DB 231 connected to the main server 10 over a network and configured to store the configuration sources of the menu board created using the menu board creation tool of the main server over the web, and a print output unit 214 configured to output the menu board, created using the menu board creation tool, through a printer 25.

In this way, in a restaurant which is an affiliated company (affiliated restaurant), a user accesses the main server 10 using the restaurant client PC 20, downloads and installs the menu board creation tool, selects menu board template information stored in the template information DB of the main server, and enters food information, thus conveniently creating a variety of menu boards. Further, the created menu board is output to a printer connected to the restaurant client PC 20 through the print output unit 214, and thus the menu board can be easily created. Further, when food items are changed or when the arrangement of the menu board or the like is intended to be changed, changed contents may be easily applied to the menu board using the menu board creation tool 111.

The main server 10 preferably includes a food information DB for storing food information which includes the names of a variety of types of food items and is represented in various languages. It is possible to prevent the names of food items from being incorrect by storing standardized correct names of food items suitable for being used with food in the food information DB 132 and by providing correct food names to respective affiliated restaurants.

The names of food items or the like are represented in various languages such as Korean, English, Japanese and Chinese and are stored in the food information DB 132, thus obtaining an advantage in that menu boards including Korean and foreign languages such as English can be easily created in each affiliated restaurant.

Meanwhile, the main server 10 includes an affiliated company DB 131 and a menu board information DB 136. The affiliated company DB 131 stores information about affiliated restaurants, such as the names, addresses, contact numbers, main food items and the history of each restaurant. The menu board information DB 136 stores the configuration sources of menu boards, which are created in affiliated restaurants by downloading and installing the menu board creation tool 111 through the restaurant client PC 20, with respect to respective affiliated restaurants.

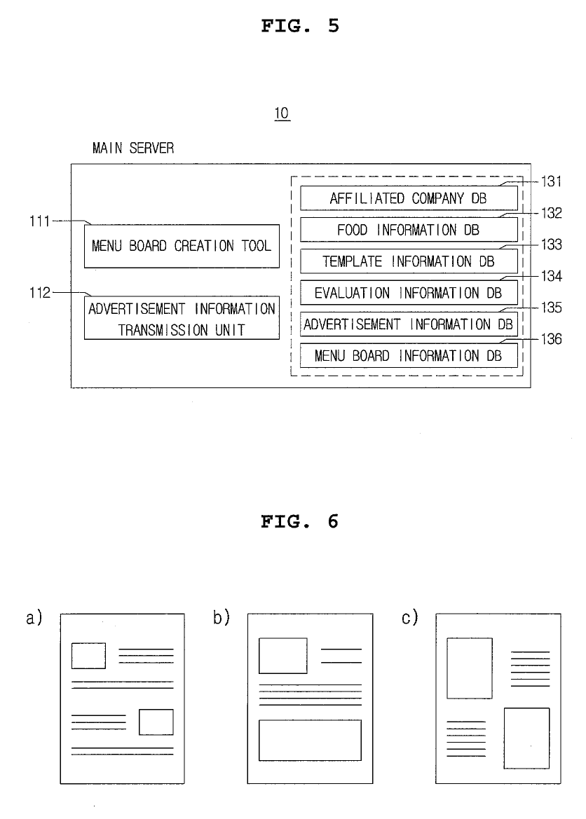

FIG. 4 is a block diagram schematically showing a food ordering system using an electronic menu board module according to the present invention.

As shown in FIG. 4, the food ordering system using an electronic menu board module according to the present invention includes a main server 10, a plurality of restaurant client PCs 20 connected to the main server 10 over a network, and a plurality of electronic menu board modules 30 communicating with the restaurant client PCs 20 in a wireless manner.

FIG. 5 is a block diagram schematically showing the construction of the main server 10.

As shown in FIG. 5, the main server 10 includes DBs for storing information about affiliated restaurants, food information, and menu board template information related to the configuration and arrangement of various menu boards, and a menu board creation tool ill for creating menu boards using the menu board template information.

The DBs includes an affiliated company DB 131, a food information DB 132, a menu board template information DB 133, and a menu board information DB 136. The affiliated company DB 131 stores information about affiliated restaurants, such as the names, addresses, contact numbers, main food items and history of the restaurants. The food information DB 132 stores food-related information such as the names, materials, cooking methods, tastes and pictures of various food items. It is possible to prevent the names of food items from being incorrect by storing the standardized correct names of food items suitable for being used with food items in the food information DB 132 and by providing the correct food names to the affiliated restaurants.

In particular, information stored in the food information DB 132 is preferably represented in various languages. The food names or the like are represented in various languages such as Korean, English, Japanese and Chinese and are stored in the food information DB 132, so that foreigners as well as natives can easily look at the menu boards of the electronic menu board modules 30 and recognize food names, materials used, cooking methods, etc., thus allowing all persons to easily select their desired food items even if they have not eaten corresponding food items before.

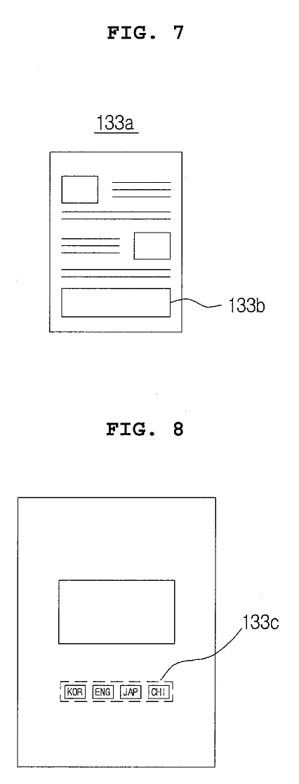

FIGS. 6A to 6C are diagrams schematically showing examples of a menu board template, and FIG. 7 is a diagram schematically showing an example of a menu board template equipped with an advertisement display unit.

As shown in FIGS. 6A to 6C, the menu board template information DB stores various types of menu board template information related to the configuration and arrangement of each electronic menu board module 30. That is, various types of menu board template information are provided to the affiliated restaurants, and thus the menu boards of the electronic menu board module 30 can be conveniently configured using the restaurant client PCs 20 in the affiliated restaurants. Further, when image pictures of food items are not present at the time of configuring the menu boards of the electronic menu board module 30, image pictures of food items are selected from the food information DB 132, and thus the electronic menu board module can be created.

The menu board information DB 136 stores the configuration sources of menu boards, which are created in affiliated restaurants by downloading and installing the menu board creation tool 111 through the restaurant client PCs 20, with respect to respective affiliated companies. In the menu board information DB 136, the configuration sources of the menu boards of affiliated restaurants are stored separately from the restaurant client PCs 20. Accordingly, even if malfunctioning occurs in a relevant restaurant client PC 20, the configuration sources of the menu board of a relevant restaurant are easily extracted from the menu board information DB 136, and thus the menu board may be reconstructed.

As shown in FIG. 5, the DBs preferably further include an advertisement information DB 135 and an evaluation information DB 134. The advertisement information DB 135 stores the advertisement information, targeted advertisement type, and other types of advertisement information of affiliated advertiser companies which desire to advertise their products in restaurants, for example, liquor shops for selling alcoholic liquors such as beer, hard liquors, and blackberry wine, and food material shops for selling food materials. As shown in FIG. 7, the menu board template information DB 133 preferably includes a menu board template equipped with an advertisement display unit on which the advertisement information of affiliated advertiser companies, stored in the advertisement information DB 135, is displayed. In an affiliated restaurant, when the electronic menu board module 30 is created by selecting a menu board template 133a equipped with an advertisement display unit 133b using the restaurant client PC 20, the advertising revenue obtained by advertising requests received from the affiliated advertiser companies is allotted to the restaurant, thus prompting various affiliated restaurants to participate in the use of the menu board template equipped with an advertisement display unit.

The evaluation information DB 134 stores information about various types of evaluation information, obtained when clients who use relevant restaurants evaluate sanitary status, the degree of kindness, food taste and smell, a sense of eating, personally captured food pictures and other types of evaluation information, with respect to the restaurants and their food.

The menu board creation tool 111 is downloaded and used after the restaurant client PC 20 accesses the main server over the network. When the menu board creation tool 111 is used, the menu boards of the electronic menu board module 30 having a desired configuration and arrangement may be easily configured in an affiliated restaurant.

Therefore, when new food items are added or existing food items are changed, or when a menu board having a new design is intended to be made, the cost and time required for the development of the design of a new menu board can be greatly reduced compared to conventional schemes.

FIG. 8 is a diagram schematically showing the configuration of a menu board equipped with a language selection unit.

A menu board creation tool 111 preferably includes a language selection unit for conveniently selecting a desired language from food information which is represented in various languages and is stored in the food information DB 132, extracting food information represented in the desired language, and displaying the food information in the desired language. As shown in FIG. 8, when a language selection unit 133c is configured on the menu board using the menu board creation tool 111, an electronic menu board module 30 supporting various languages can be conveniently constructed in an affiliated restaurant. Accordingly, foreigners undergoing communication difficulties not only can easily and freely select and order desired food items, but also can learn about the food culture and table manners of respective countries without bumping into the language barrier.

Further, when the advertisement information DB 135 is provided in the DBs of the main server 10, an advertisement information transmission unit 112 for transmitting the advertisement information, stored in the advertisement information DB 135, to the restaurant client PC 20 is further provided in the main server, as shown in FIG. 5.

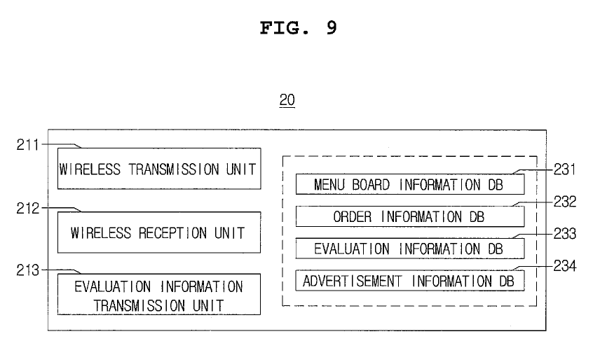

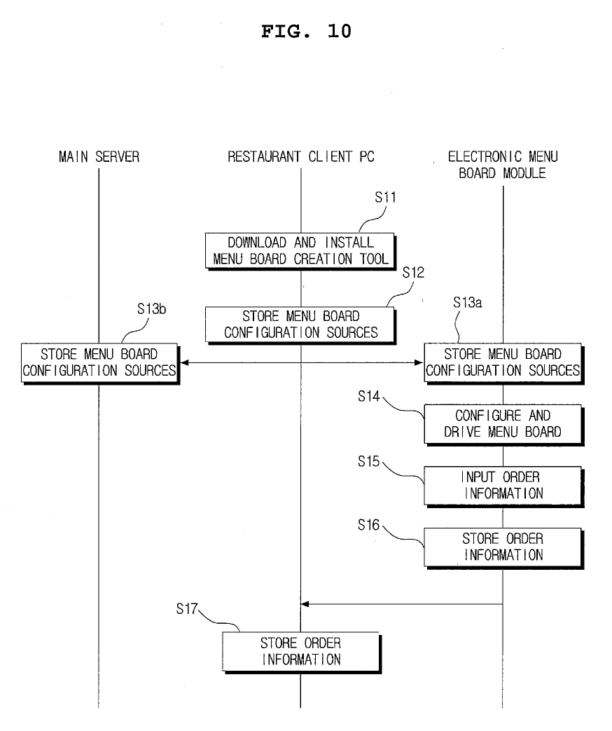

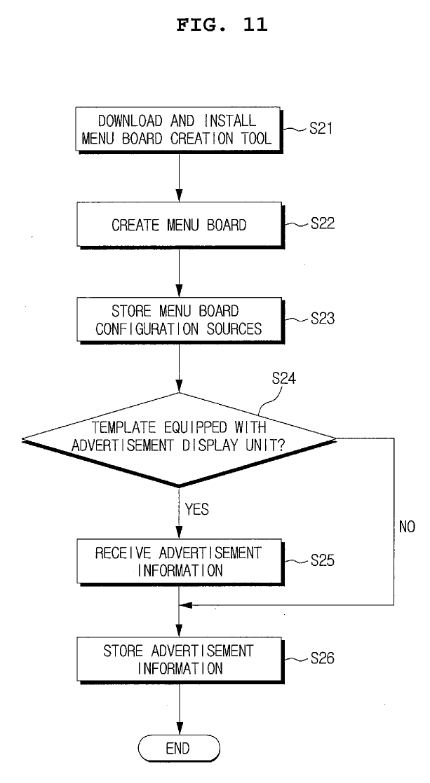

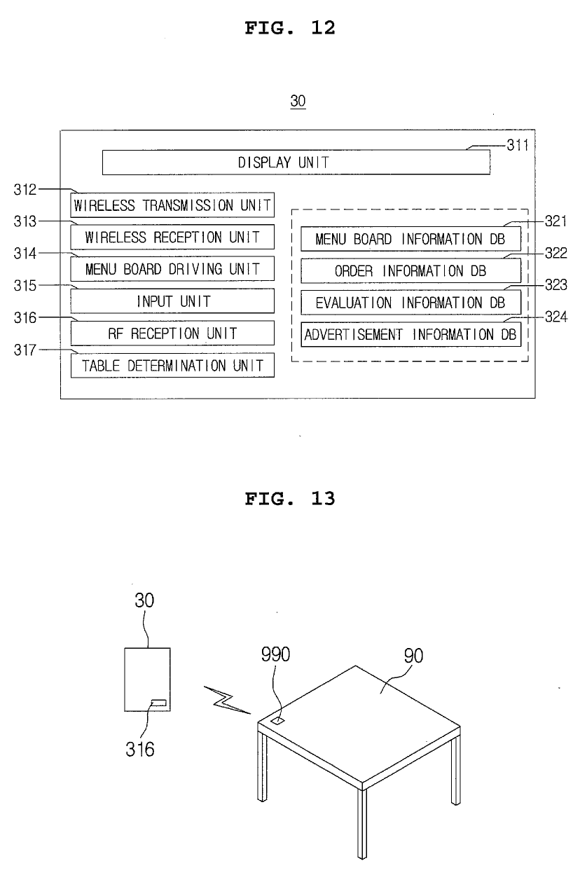

FIG. 9 is a diagram schematically showing the construction of the restaurant client PC 20, and FIG. 10 is a flowchart schematically showing the flow of the food ordering system.

As shown in FIG. 9, the restaurant client PC 20 is connected to the main server 10 over the network, and includes a menu board information DB 231, an order information DB 232, an evaluation information DB 233, an advertisement information DB 234, a wireless transmission unit 211, a wireless reception unit 212, and an evaluation information transmission unit 213.

The menu board information DB 231 stores the configuration sources of menu boards created using the menu board creation tool 111 which is downloaded and installed when the restaurant client PC 20 accesses the main server 10 at step S11. In an affiliated restaurant, a menu board can be conveniently created by selecting a menu board template and food information from the menu board template information DB 133 and the food information DB 132, respectively, using the menu board creation tool 111, and the configuration sources of the created menu board are stored in the menu board information DB 231. Further, the menu board configuration sources stored in the menu board information DB 231 are transmitted to the menu board information DB 136 of the main server 10 over the network, and are stored therein at step S13b. Further, the menu board configuration sources stored in the menu board information DB 231 of the restaurant client PC 20 are transmitted to the electronic menu board module 30 in a wireless manner, and are then stored in the menu board information DB 321 of the electronic menu board module 30, which will be described later, at step S13a.

The order information DB 232 stores order-related information such as a table number, the type and number of food items, and food prices received from the electronic menu board module 30 at step S17. In detail, when order information is input to the electronic menu board module 30, the order information is stored in the order information DB 322 of the electronic menu board module 30, is transmitted to the restaurant client PC 20 in a wireless manner and is then stored in the order information DB 232 of the restaurant client PC 20 at steps S15 to S17.

The evaluation information DB 233 stores evaluation information received from the electronic menu board module 30, for example, the degree of kindness and the sanitary status of a relevant restaurant, the taste and smell of food items, and food pictures. The evaluation information stored in the evaluation information DB 233 is transmitted to the main server 10 through the evaluation information transmission unit 213. The evaluation information transmitted to the main server 10 is stored in the evaluation information DB 134 of the main server 10.

The advertisement information DB 234 receives the advertisement information, which will be described later.

The wireless transmission unit 211 transmits the menu board configuration sources stored in the menu board information DB 231 to the electronic menu board module 30 in a wireless manner. The wireless reception unit 212 receives order information from the electronic menu board module 30 in a wireless manner, and the received order information is stored in the order information DB 232.

FIG. 11 is a flowchart schematically showing the reception of advertisement information by the restaurant client PC 20.

When a menu board is created using the menu board creation tool 111 which is downloaded by the restaurant client PC 20 from the main server 10 and is installed in the restaurant client PC 20 at steps S21 and S22, the configuration sources of the menu board are stored in the menu board information DB 231 of the restaurant client PC 20 at step S23. When the menu board template required to configure the menu board is a template equipped with the advertisement display unit 133a (of FIG. 7), the restaurant client PC 20 receives relevant advertisement information from the main server 10, and the received advertisement information is stored in the advertisement information DE 234 of the restaurant client PC 20 at steps S24 to S26.

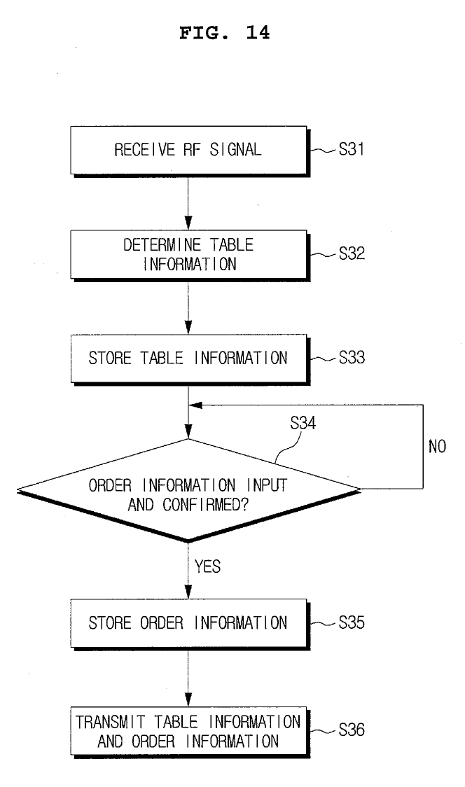

FIG. 12 is a diagram schematically showing the configuration of the electronic menu board module 30.

As shown in FIG. 12, the electronic menu board module 30 includes a wireless reception unit 313, a wireless transmission unit 312, a menu board driving unit 314, a display unit 311, an input unit 315, a menu board information DB 321, an order information DE 322, an evaluation information DE 323 and an advertisement information DE 324.

The wireless reception unit 313 receives the configuration sources of a menu board transmitted through the wireless transmission unit 211 of the restaurant client PC 20 in a wireless manner. The menu board configuration sources received by the wireless reception unit 313 are stored in the menu board information DB 321 at step S13a (of FIG. 10).

The menu board driving unit 314 creates and drives a menu board by analyzing the menu board configuration sources stored in the menu board information DB 321, and the menu board driven by the menu board driving unit is output to the display unit at step S14. The display unit 311 may be implemented using a Liquid Crystal Display (LCD) or the like.

The input unit 315 is configured to receive order information such as food items on the basis of the menu board output to the display unit 311. Any input unit such as a keypad may be sufficiently used as long as the input unit enables order information such as food items, output to the display unit 311, to be selected and input.

In order to more conveniently select and input food items, the display unit 311 and the input unit 315 may be preferably implemented as a touch screen.

When food items are selected using the input unit 315, information about the type and number of food items and prices calculated based on the food items is stored in the order information DB 322. The evaluation information DB 323 stores evaluation information input through the input unit 315, such as information about the degree of kindness and sanitary status of a restaurant, information about the taste and smell of food items, and food pictures. When a menu board is created by selecting a menu board template equipped with the advertisement display unit 133a (of FIG. 7), the advertisement information DB 324 stores advertisement information stored in the advertisement information DB 234 of the restaurant client PC 20.

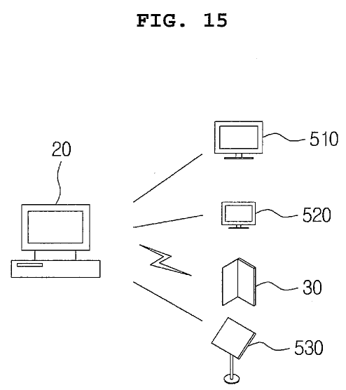

FIG. 13 is a diagram schematically showing a menu board and a table, and FIG. 14 is a flowchart schematically showing a process in which an electronic menu board module determines table information.

As shown in FIG. 13, in each table 90 of a restaurant, a Radio Frequency Identification (RFID) tag 990 in which information about the number of each table is stored is provided. An electronic menu board module 30 includes an RF reception unit 316 for receiving an RF signal from the RFID tag 990 and a table determination unit 317 (refer to FIG. 12) for determining table information in response to the RF signal received by the RF reception unit 316.

In detail, as shown in FIG. 14, when the RF reception unit 316 of the electronic menu board module 30 receives an RF signal from the RFID tag 990 of the table 90 at step S31, the table determination unit 317 determines relevant table information and stores the table information in the order information DB 322 at steps S32 and S33. Further, when order information is input from the input unit 315 of the electronic menu board module 30 and is confirmed, the order information is stored in the order information DB 322, and both the table information and order information stored in the order information DB 322 are transmitted to the restaurant client PC 20 at steps S34 to S36.

As described above, since the table information is determined by the components such as the RFID tag 990 and the RF reception unit 316, there is an advantage in that inconvenience of causing a member of the staff or a customer to personally enter table information is eliminated.

FIG. 15 is a diagram schematically showing the provision of a kitchen terminal, a serving member terminal and a bulletin terminal.

As shown in FIG. 15, a food ordering system using an electronic menu board module according to the present invention may further include a kitchen terminal 510, a serving member terminal 520, and a bulletin terminal 530 which communicate with the restaurant client PC 20.

When order information is received by the restaurant client PC 20 from the electronic menu board module 30, it is preferable to notify a member of the cooking staff of order information by transmitting the order information to the kitchen terminal 510 and the serving member terminal 520, thus allowing the member of the cooking staff to immediately start to cook. Further, when the cooking of food is completed, and information about the completion of food is transmitted from the kitchen terminal 510 to the restaurant client PC 20, the information about the completion of food is transmitted to the serving member terminal 520, thus allowing a member of the serving staff to deliver the food to the customer immediately after the food has been cooked.

Further, the bulletin terminal 530 is located on the front of the gate of the restaurant, so that information stored in the menu board information DB 231 of the restaurant client PC 20 is transmitted to the bulletin terminal 530, thus easily notifying tourists, as well as customers, of the menu items of the restaurant.

As described above, a system for creating a menu board according to the present invention is advantageous in that it can allow menu boards to be conveniently created at a low cost in restaurants, and to be easily changed and created when menu items are changed, and, in particular, can prevent the names of food items from being incorrect.

Further, a food ordering system using an electronic menu board module according to the present invention is advantageous in that it not only can easily change and update an existing menu board without requiring the creation of a new menu board when food items are added in restaurants, but also can prevent the names of food items from being incorrect by providing unified food information represented in various languages to restaurants, and can allow foreign tourists to easily select desired food items by informing the foreign tourists of correct food information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for creating a menu board, comprising:
a main server including a template information database (DB) for storing menu board template information related to configuration and arrangement of various menu boards, and a menu board creation tool for creating a menu board using the menu board template information stored in the template information DB; and
at least one restaurant client Personal Computer (PC) connected to the main server over a network, and configured to include a menu board information DB for storing configuration sources of each menu board, created using the menu board creation tool of the main server, over a web and a print output unit for outputting the menu board, created using the menu board creation tool, through a printer,
wherein the menu board created using the menu board creation tool is printed through the printer and is usable as a typical menu board.

2. The system according to claim 1, wherein the main server comprises a food information DB for storing food information which includes names of various food items and is represented in various languages.

3. A food ordering system using an electronic menu board module, comprising:
a main server including a main board creation tool for creating a menu board using menu board template information related to configuration and arrangement of various menu boards;
at least one restaurant client Personal Computer (PC) connected to the main server over a network, and configured to include a menu board information DB for storing configuration sources of each menu board, created using the menu board creation tool of the main server, over a web, a wireless transmission unit for transmitting the menu board configuration sources in a wireless manner, a wireless reception unit for receiving order information in a wireless manner, and an order information DB for storing the order information received by the wireless reception unit; and
a plurality of electronic menu board modules, each including a wireless reception unit for receiving configuration sources of a menu board, transmitted from the restaurant client PC, in a wireless manner, a menu board information DB for storing the menu board configuration sources received by the wireless reception unit, a menu board driving unit for configuring and driving the menu board by analyzing the menu board configuration sources received by the wireless reception unit, a display unit for outputting the menu board driven by the menu board driving unit, an input unit for selecting and inputting food items based on the menu board output to the display unit, an order information DB for storing the order information input to the input unit, and a wireless transmission unit for transmitting the order information to the restaurant client PC.

4. The food ordering system according to claim 3, wherein:
the main server comprises a food information DB for storing food information which includes names, materials, cooking methods and taste of various food items and is represented in various languages, and
the menu board creation tool comprises a language conversion unit for conveniently converting the food information into information in a specific language.

5. The food ordering system according to claim 3, wherein:
each table of the restaurant comprises a Radio Frequency Identification (RFID) tag for storing table information,
each of the electronic menu board modules comprises a Radio Frequency (RF) reception unit for receiving an RF signal from the RFID tag, and a table determination unit for determining table information in response to the RF signal received by the RF reception unit, and
the wireless transmission unit of the electronic menu board module transmits the table information determined by the table determination unit to the restaurant client PC.

6. The food ordering system according to claim 3, wherein:
the menu board template information stored in the main server comprises a menu board template equipped with an advertisement display unit, and
the main server further comprises an advertisement information DB for storing advertisement information, targeted advertisement type, and other types of advertisement-related information of an affiliated advertiser company, and an advertisement information output unit for transmitting the advertisement information stored in the advertisement information DB to the restaurant client PC.

7. The food ordering system according to claim 3, wherein:
the menu board driven by the electronic menu board module comprises an evaluation display unit for enabling evaluation of respective food items and results of the evaluation to be checked, and
the results of the evaluation of the food items performed using the input unit and displayed by the evaluation display unit are stored in an evaluation information DB, and the results of the evaluation of the food items stored in the evaluation information DB are stored both in the restaurant client PC and in the main server.
